(19) United States
(12) Patent Application Publication
(10) Pub. No.: US 2013/0248790 A1
(43) Pub. Date: Sep. 26, 2013

(54) Apparatus for Spooling An Anchor Line

(71) Applicants: Earl James Cavalier, JR., Chauvin, LA (US); Britt David Cavalier, Houma, LA (US); Jason A. Turner, Houma, LA (US); Woodrow M. Hines, Houma, LA (US)

(72) Inventors: Earl James Cavalier, JR., Chauvin, LA (US); Britt David Cavalier, Houma, LA (US); Jason A. Turner, Houma, LA (US); Woodrow M. Hines, Houma, LA (US)

(21) Appl. No.: 13/427,318

(22) Filed: Mar. 22, 2012

(51) Int. Cl. B63B 21/04; B66D 1/38

(52) U.S. Cl. 254/393

(57) ABSTRACT

A spooling assembly is mountable between a marine anchor and a rotatable winch spool to facilitate spiral winding of the anchor line of the spool. The spooling assembly has an independent power source, which moves a chain and a trolley connected to the chain along a path substantially parallel to a longitudinal axis of the spool. The trolley has rotating element, between which the anchor line is engaged. The anchor line is oriented in a direction substantially transverse to the longitudinal axis of the spool. When the trolley moves to and fro along set tracks the anchor line is guided to wind on the winch spool in a spiral manner. An emergency release air clutch allows freespooling of the anchor.

### BACKGROUND OF THE INVENTION

This invention relates to raising and lowering of marine anchors, and more particularly, to an apparatus for guiding an anchor line as it is being spooled to an onboard winch.

For centuries marine vessels have utilized anchors. In general an anchor is a device designed to engage the bottom of a body of water and resist misplacement forces acting on the marine vessel. The anchor is secured to the vessel by an anchor line, which can be a cable, chain, or rope. The anchor line is traditionally wound (or “spooled”) onto flanged drums and barrels for storage and to facilitate paying out of the line, as it is needed. Most vessels have bow chocks, which are fittings usually on the rail of the bow of a vessel, which serve as fairleads for the anchor line, or anchor rode. Typically, two bower anchors are used on the vessel, each operationally connected to a respective windlass.

The anchor line of each anchor is distributed evenly along the length of the spool drum or spool barrel so that the maximum amount of line can be wound onto a single barrel. While in larger boats, spooling gear is used to guide the line onto the barrel surface in the desired position along the length of the barrel smaller boats rely on manual guiding. A deckhand uses a crow bar to guide the anchor line and prevent overlapping of the line in one location of the spool drum. As the spool is rotated the deckhand moves the crow bar parallel to the axis of the drum to gradually move the anchor line and cause it to wind on the spool barrel in a spiral fashion.

When the anchor line reaches the end of the drum and comes in contact with the flange the deckhand reverses his position and guides the anchor line to the opposite flange. The second anchor line has to be spooled in the same fashion on a separate spool on the opposite side of the boat. Such process is not only time consuming but is also labor intensive. The present invention contemplates elimination of drawbacks associated with the conventional spooling methods and provision of an apparatus for anchor line spooling that distributes the anchor line in a spiral fashion along the length of the winch drum to achieve a level wind of the anchor line.

### SUMMARY OF THE INVENTION

It is, therefore, an object of the present invention to provide an apparatus and method for spooling an anchor line in a spiral manner over a winch drum.

It is another object of the invention to provide an apparatus for spooling an anchor line that can be easily disengaged when the anchor is being paid out such as during freespooling.

It is a further object of the invention to provide an anchor line spooling apparatus that is equipped with a disengaging clutch for releasing the rode during freespooling.

These and other objects of the invention are achieved through a provision of a spooling assembly is mountable between a marine anchor and a rotatable winch spool to facilitate spiral winding of the anchor line of the spool. The spooling assembly has an independent power source, which moves a chain and a trolley connected to the chain along a path substantially parallel to a longitudinal axis of the spool. The trolley has rotating element, between which the anchor line is engaged. The anchor line is oriented in a direction substantially transverse to the longitudinal axis of the spool. When the trolley moves to and fro along set tracks the anchor line is guided to wind on the winch spool in a spiral manner. An emergency release air clutch allows freespooling of the anchor.

### BRIEF DESCRIPTION OF THE DRAWINGS

Reference will now be made to the drawings, wherein like parts are designated by like numerals, and wherein

FIG. 1 is a schematic view illustrating position of the apparatus of the present invention on a boat.

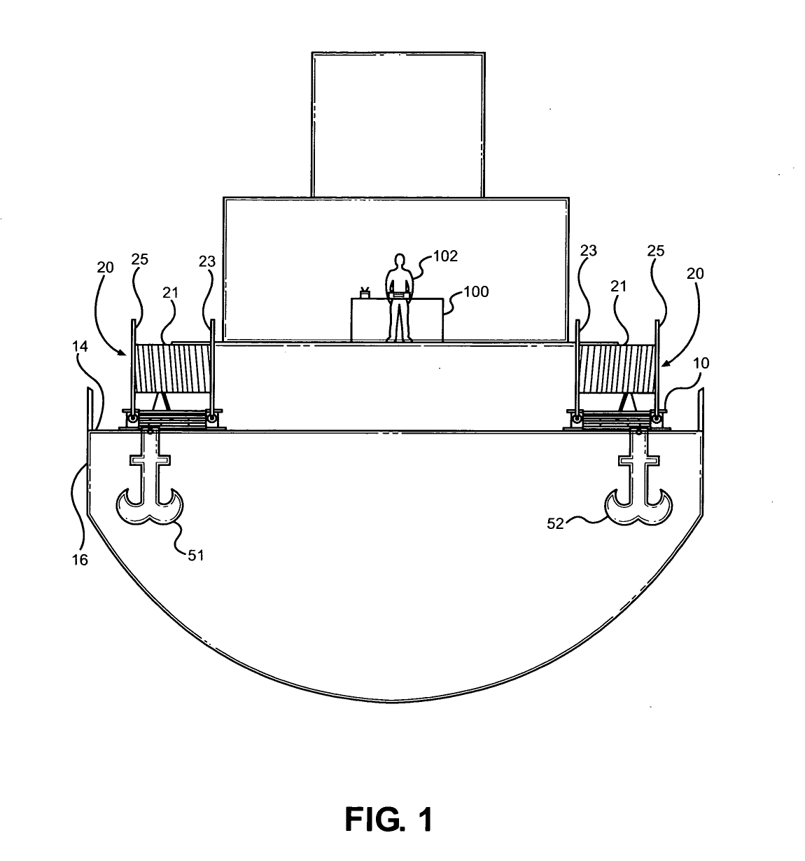

FIG. 2 is a perspective view of the anchor line spooling apparatus according to the present invention.

FIG. 3 is top view of the anchor line spooling apparatus according to the present invention.

### DETAIL DESCRIPTION OF THE INVENTION

Turning now to the drawings in more detail, numeral 10 designates the apparatus for spooling an anchor line according to the present invention. The apparatus 10 comprises a base plate 12 configured for mounting on a deck 14 of a boat 16. The base plate 12 has a generally L-shaped configuration, with a first longer portion 18 extending a direction generally parallel to an axis of rotation of a winch drum or winch barrel 21 of a winch 20. A second shorter portion 22 of the base plate 12 extends at a right angle to the first portion 18. The base 12 can be formed from a variety of rigid materials.

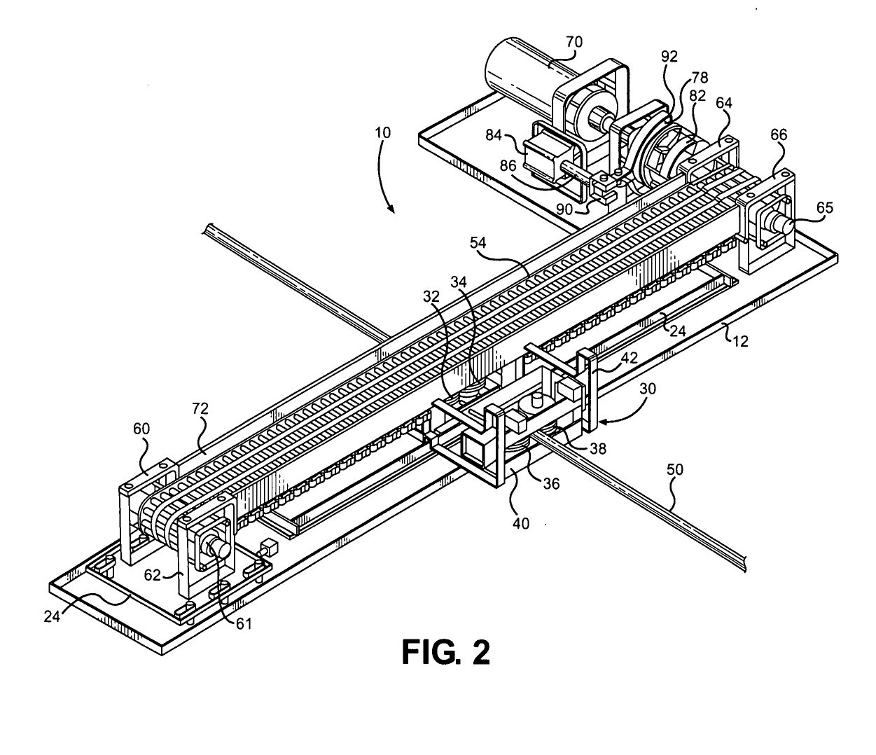

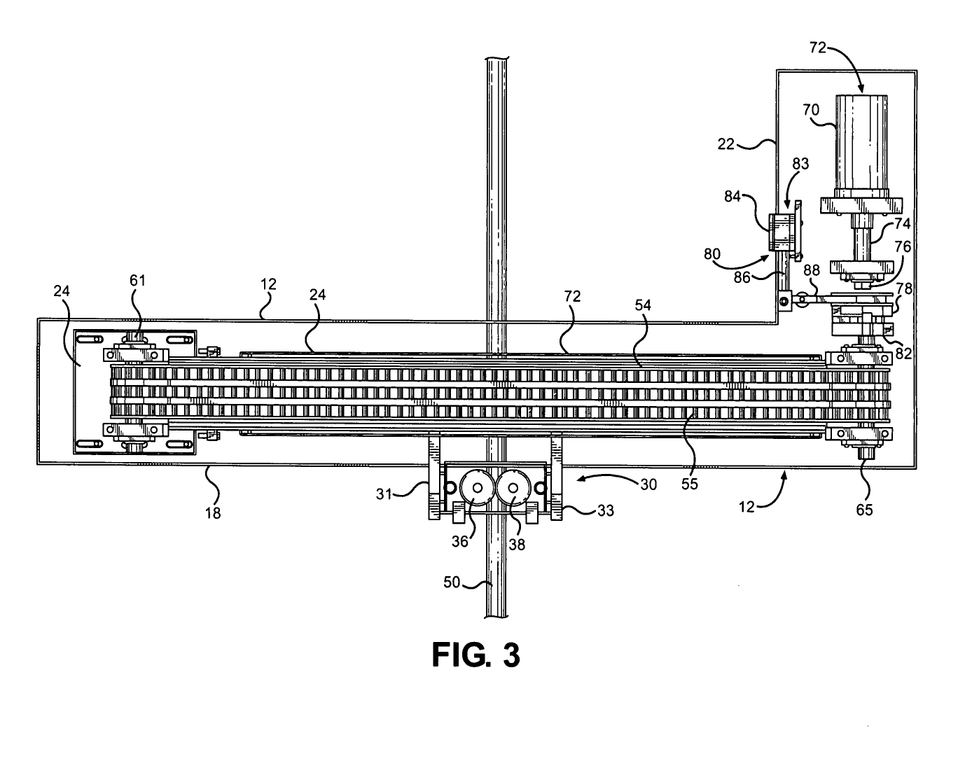

A support frame 24 is configured for mounting on the base plate 12; the support frame 24 is mounted within the borders defined by the base plate 12, as shown in FIGS. 2 and 3. The support frame 24 acts as a lower travel guide for a sliding trolley assembly 30, which is adapted to move in a direction substantially parallel to the axis of rotation of the winch drum 20. The support frame 24 can be formed from an angle iron or similar material and have a rectangular configuration extending along a major part of the first portion 18 and into the second portion 22 of the base plate 12.

An adjustable stanchion plate 26 is secured to the base plate 12 adjacent the support frame 24. The stanchion plate can be secured to the base plate 12 using bolts, screws and the like. The stanchion plate 26 supports stanchions of the chain assembly, as will be explained below.

The trolley assembly 30 comprises four rollers 32, 34, 36, and 38, which are rotatably mounted between a lower travel guide 40 and an upper travel guide 42. The travel guides 40 and 42 can be formed from Teflon if desired. The rollers 32, 34, 36, and 38 are positioned in pairs, with the roller 36 being in front of the roller 32, and the roller 38 being in front of the roller 34. The rollers are spaced from each other to a distance sufficient for an anchor cable 50 to pass between them from an anchor 52 to the winch drum 20. It will be understood that a second spooling apparatus 10 is mounted for use with the second winch mounted on the boat 16 for spooling the cable 50 from the second anchor 51 to the second winch drum 21.

The lower travel guide 40 slides along the path defined by the support frame 24. The longitudinal dimensions of the support frame 24 are substantially equal to the longitudinal dimensions of the winch drum 20, 21 so that the trolley assembly 30 moves back and forth in front and parallel to, the winch drum 20, 21 when spooling the rode 50. The upper travel guide 42 engages a chain assembly 54, which is mounted above the base plate 12 using stanchion blocks 60, 62, 64, and 66.

A sprocket 61 is supported by the stanchions 60, 62, and a sprocket 65 is supported by the stanchions 64, 66. The sprocket 65 is operationally connected to a power source 70, which can be a hydraulic or electric motor. A top chain tray 72 extends between the stanchions 60, 62 and 64, 66 supporting the chain assembly 54 above the trolley assembly 30.

The top chain tray 72 can have a generally H-shaped cross section with upwardly and downwardly extending flanges, so that a chain 55 of the chain assembly 54 travels within a trough defined in part by the upwardly extending flanges. In this manner, a possibility of the chain displacement with respect to the top chain tray 72 is minimized. The chain 55 wraps almost entirely around the chain tray 72 and is attached, at it's opposite ends, to retaining blocks 31, 33 of the trolley assembly 30. If desired, a Teflon wear pad can be positioned between the top chain tray 72 and the chain 54 to minimize wear on the top chain tray 72.

A power assembly 72 comprises the motor 70 having a rotating drive shaft 74 extending therefrom. A distant end 76 of the drive shaft 74 has a generally square cross section. The distant end 76 is configured for engaging a male jaw clutch 78, which forms a part of a clutch assembly 80. The clutch assembly 80 is mounted between the sprocket 65 and the power source 70 and is configured to disengage the chain assembly from the power source during freespooling. A female jaw clutch 82 is configured for mating engagement with the male jaw clutch 78. The female jaw clutch is stationary, while the male jaw clutch is configured for co-axial movement between an engaged position with the female jaw clutch and a disengaged position.

A clutch assembly 83 is operatively mounted between the chain assembly 54 and the power source 70. The clutch assembly comprises an air cylinder 84, which is provided with a reciprocating arm 86. A free end of the reciprocating arm 86 is connected to a pivotal arm 88. The reciprocating arm 86 extends in a substantially parallel relationship to the drive shaft 74, while the pivotal arm extends at a right angle thereto. The pivotal arm 88 is engaged by a pivot pin to a bracket 90 through which the reciprocating arm 86 extends. The pivotal arm 88 carries a yoke 92, which supports the male jaw clutch 78.

When the reciprocating arm 86 of the clutch assembly 83 is activated by the clutch air cylinder 84 the male jaw clutch 78 moves into engagement with the female jaw clutch to transmit torque from the drive shaft 74 to the drive sprocket 65 and thus to the chain assembly 54. During freespooling, the air clutch assembly is disengaged, and the male jaw clutch is moved out of engagement with the stationary female jaw clutch 82. The torque is then is no longer transmitted to the drive sprocket 65 and the chain assembly 54, allowing the anchor 51, 52 to lower unto the water in a freespooling style.

The power assembly 72 and the clutch assembly 83 are operationally connected to an onboard control 100. An operator 102 can operate the starboard or port spooling apparatus 10 by synchronizing movement of the trolley assemblies 30 mounted between the winches 20 and the bower anchors 51, 52. When the anchors 51, 52 need to be lifted the winches 20 are energized by separate power means (not shown). The drums begin to rotate winding the cable or rode 50 onto the drums. Contemporaneously, the operator 102 activates the spooling assembly 10 by engaging the air clutch assembly 30 to the power source assembly 70 and delivering movement to the chain assembly 54. The operator 102 can set the speed of to and fro movement of the trolley, synchronized with rotation of the drum of the winch.

The trolley assembly 30 is activated by the movement of the chain assembly 54, pulling the trolley back and forth along the tracks of the support frame 24. As the rollers 32-38 rotate, the anchor cable 50 is guided for winding on the winch drum 21 along the drum's entire length, not just on top of each other, moving in a direction substantially transverse to the longitudinal axis of the winch drum. Since the length of the tracks of the support frame 24 is substantially equal to the length of the winch drum 21, the rode 50 is wound in a spiral fashion along the entire length of the winch drum 21. The direction of the trolley is reversed 180 degrees once the operator sees that the rode 50 reached one or the other of the flanges 23 or 25 of the winch drum 21. Once the anchor rode has been spooled, the spooling assembly 10 can be de-energized.

When the anchor 50, 51 needs to be lowered into the water the spooling assembly 10 can be energized again and the anchor gradually lowered into the water. During freespooling the apparatus 10 is deactivated by the clutch assembly 83 allowing the anchor line 50 to quickly move between the rollers as it is being pulled by the anchor. The clutch assembly offers a safety feature when the anchor line needs to be release in an emergency.

The spooling apparatus of the present invention provides an easy to operate and efficient guiding assembly for controlling direction of the anchor line as it is being paid out or pulled for winding on a winch spool. It can be modified in both arrangement and detail. For example, a sensor assembly could be provided for synchronizing rotation of the winch drum and the trolley movement. Any number or combination of panel mounted and handheld control circuits can be used on the control 100. They may be all connected to the same sensor assembly so that the winches and the spooling assemblies will all work in unison.

Many other changes and modifications can be made in the design of the present invention without departing from the spirit thereof. I, therefore, pray that my rights to the present invention be limited only by the scope of the appended claims.

I claim:

1. An anchor line spooling apparatus for controlling direction of an anchor line with respect to a winch spool on a marine vessel, the apparatus comprising:
a guiding assembly mountable on the marine vessel between the winch spool and an anchor, said guiding assembly comprising rotatable elements between which the anchor line is directed for winding the anchor line on the winch spool in a spiral manner.

2. The apparatus of claim 1, said guiding assembly being energizable independently from the winch spool.

3. The apparatus of claim 1, said guiding assembly comprising a power source assembly, a chain assembly energizable by the power source assembly, and a trolley assembly operationally connected to the chain assembly, said trolley assembly engaging the anchor line.

4. The apparatus of claim 3, the chain assembly comprising a plurality of spaced-apart stanchion members, a chain tray secured to said stanchion members, and a chain engaging the chain tray.

5. The apparatus of claim 4, said guiding assembly comprising guiding tracks mounted on said vessel below the chain.

6. The apparatus of claim 4, said guiding tracks have a pre-determined longitudinal dimension substantially equal to longitudinal dimensions of the winch spool.

7. The apparatus of claim 4, said guiding tracks extending substantially parallel to a longitudinal axis of the winch spool.

8. The apparatus of claim 5, the trolley assembly comprising a trolley configured for engaging and moving along, the guiding tracks in the direction substantially parallel to the longitudinal axis of the winch spool.

9. The apparatus of claim 8, said trolley being provided with retaining blocks configured for engaging opposite ends of the chain and moving the trolley to and fro along the guiding tracks when the chain assembly is energized.

10. The apparatus of claim 7, said trolley assembly comprising a plurality of spaced-apart rollers, said rollers being configured to engage the anchor line and move the anchor line to and fro along a path determined by longitudinal dimensions of the guiding tracks in a direction substantially transverse to a longitudinal axis of the winch spool.

11. The apparatus of claim 3, further comprising a clutch assembly configured to disengage operational connection between the chain assembly and the power source assembly upon demand.

12. The apparatus of claim 11, the clutch assembly comprising an air clutch cylinder, a stationary female jaw clutch, a movable male jaw clutch, and a means for moving the male jaw clutch between a position engaging the female jaw clutch and a position disengaged from the female jaw clutch.

13. The apparatus of claim 12, said clutch assembly comprising a pivotal arm mounted between the male jaw clutch and the air clutch cylinder, said pivotal arm moving the male jaw clutch between the engaged and disengaged position with respect to the female jaw clutch.

14. The apparatus of claim 3, said power source assembly comprising a motor configured for imparting movement on the chain assembly and the trolley assembly.

15. The apparatus of claim 14, wherein said motor is a hydraulic motor operating independently from the winch spool.

16. The apparatus of claim 3, further comprising a control member configured for controlling operation of the power source assembly, the chain assembly and the trolley assembly.

17. An anchor line spooling apparatus for controlling direction of an anchor line with respect to a winch spool on a marine vessel, the apparatus comprising:
a guiding assembly mountable on the marine vessel between the winch spool and an anchor, said guiding assembly comprising rotatable elements between which the anchor line is directed for winding the anchor line on the winch spool in a spiral manner, said guiding assembly comprising a power source assembly, a chain assembly energizable by the power source assembly, a trolley assembly operationally connected to the chain assembly, said trolley assembly engaging the anchor line, and a control means mountable on the marine vessel for controlling operation of the power assembly, the chain assembly and the trolley assembly.

18. The apparatus of claim 17, further comprising a clutch assembly configured to disengage operational connection between the chain assembly and the power source assembly upon demand.

19. The apparatus of claim 17, said guiding assembly being energizable independently from the winch spool.

20. The apparatus of claim 17, the chain assembly comprising a plurality of spaced-apart stanchion members, a chain tray secured to said stanchion members, and a chain engaging the chain tray.

21. The apparatus of claim 20, said guiding assembly comprising guiding tracks mounted on said vessel below the chain.

22. The apparatus of claim 21, said guiding tracks have a pre-determined longitudinal dimension substantially equal to longitudinal dimensions of the winch spool, said guiding tracks being configured to guide the trolley assembly along the guiding tracks in a direction substantially parallel to the longitudinal axis of the winch spool.

23. The apparatus of claim 21, said trolley being provided with retaining blocks configured for engaging opposite ends of the chain and moving the trolley to and fro along the guiding tracks when the chain assembly is energized.

24. The apparatus of claim 21, said trolley assembly comprising a plurality of spaced-apart rollers, said rollers being configured to engage the anchor line and move the anchor line to and fro along a path determined by longitudinal dimensions of the guiding tracks in a direction substantially transverse to a longitudinal axis of the winch spool.

25. The apparatus of claim 18, the clutch assembly comprising an air clutch cylinder, a stationary female jaw clutch, a movable male jaw clutch, and a means for moving the male jaw clutch between a position engaging the female jaw clutch and a position disengaged from the female jaw clutch.

26. The apparatus of claim 25, said clutch assembly comprising a pivotal arm mounted between the male jaw clutch and the air clutch cylinder, said pivotal arm moving the male jaw clutch between the engaged and disengaged position with respect to the female jaw clutch.

27. The apparatus of claim 17, said power source assembly comprising a motor configured for imparting movement on the chain assembly and the trolley assembly.

28. The apparatus of claim 27, wherein said motor is a hydraulic motor operating independently from the winch spool.

29. The apparatus of claim 17, further comprising a control member configured for controlling operation of the power source assembly, the chain assembly and the trolley assembly.

30. A method of controlling direction of winding of an anchor line with respect to a winch spool on a marine vessel, the method comprising the steps:
providing a guiding assembly mountable on the marine vessel between the winch spool and an anchor, said guiding assembly comprising rotatable elements;
extending the anchor line between the rotating elements such that the rotating elements are positioned between an anchor and the winch spool;
causing movement of the rotating elements in a direction substantially parallel to a longitudinal axis of rotating winch spool, thereby causing the anchor line to wind on the winch spool in a spiral manner.

31. The method of claim 30, wherein the guiding assembly comprises a power source assembly energizable independently from the winch spool, a chain assembly operationally connected to the power source assembly, and a trolley assembly operationally connected to the chain assembly and configured for movement along a pre-determined path with respect to the winch spool.

32. The method of claim 31, comprising a step of providing a control means mountable on the marine vessel for controlling operation of the power assembly, the chain assembly and the trolley assembly.

33. The method of claim 31, further comprising a step of providing a clutch assembly configured to disengage operational connection between the chain assembly and the power source assembly upon demand.

34. The method of claim 31, said chain assembly comprising a plurality of spaced-apart stanchion members, a chain tray secured to said stanchion members, and a chain engaging the chain tray.

35. The method of claim 34, comprising a step of providing guiding tracks and mounting the guiding tracks on said vessel below the chain, said guiding tracks having a pre-determined longitudinal dimension substantially equal to longitudinal dimensions of the winch spool.

36. The method of claim 35, comprising a step of guiding the trolley assembly to and fro along the guiding tracks in a direction substantially parallel to the longitudinal axis of the winch spool.

37. The method of claim 36, said trolley being provided with retaining blocks configured for engaging opposite ends of the chain and moving the trolley to and fro along the guiding tracks when the chain assembly is energized.

38. The method of claim 36, said trolley assembly comprising a plurality of spaced-apart rollers, said rollers being configured to engage the anchor line in a direction substantially transverse to the longitudinal axis of the winch spool.

39. The method of claim 33, the clutch assembly comprising an air clutch cylinder, a stationary female jaw clutch, a movable male jaw clutch, and a means for moving the male jaw clutch between a position engaging the female jaw clutch and a position disengaged from the female jaw clutch.

40. The method of claim 39, said clutch assembly comprising a pivotal arm mounted between the male jaw clutch and the air clutch cylinder, said pivotal arm moving the male jaw clutch between the engaged and disengaged position with respect to the female jaw clutch.

41. The method of claim 31, said power source assembly comprising a motor configured for imparting movement on the chain assembly and the trolley assembly.

42. The method of claim 41, wherein said motor is a hydraulic motor operating independently from the winch spool.
